(19) United States
(12) Patent Application Publication
(10) Pub. No.: US 2013/0242837 A1
(43) Pub. Date: Sep. 19, 2013

(54) METHOD AND APPARATUS FOR PROCESSING HYBRID AUTOMATIC REPEAT REQUEST PROCESS

(71) Applicants: Tao Yang, PuDong Jinqiao Shanghai (CN); Chandrika Worrall, Newbury (GB)

(72) Inventors: Tao Yang, PuDong Jinqiao Shanghai (CN); Chandrika Worrall, Newbury (GB)

(73) Assignee: ALCATEL LUCENT, Paris (FR)

(21) Appl. No.: 13/876,316

(22) PCT Filed: Sep. 14, 2011
(86) PCT No.: PCT/IB11/02465

§ 371 Date: Jun. 6, 2013

(30) Foreign Application Priority Data
Sep. 30, 2010 (CN) 201010506431.7

(51) Int. Cl. H04W 52/02

(52) U.S. Cl. CPC H04W 52/0225
USPC 370/311

(57) ABSTRACT

Embodiments of the present invention provide an improved method and apparatus for processing an uplink component carrier hybrid automatic repeat request process. The method comprises: receiving an indication that a downlink component carrier is de-activated; stopping receiving a physical hybrid retransmission indicator channel from the de-activated downlink component carrier; and stopping processing an uplink component carrier hybrid automatic repeat request process scheduled by the de-activated downlink component carrier.

### FIELD OF THE INVENTION

The present invention relates to a carrier aggregation system, particular to a method and apparatus for processing a hybrid automatic repeat request (HARQ) process for an uplink component carrier (ULCC) of the carrier aggregation system.

### BACKGROUND OF THE INVENTION

LTE-Advanced introduces the carrier aggregation technology to support work in a broader bandwidth. The carrier aggregation can jointly server the user equipment (UE) by integrating a plurality of discrete frequency bands. Considering backward compatibility with the LTE, LTE-Advanced introduces a concept of component carrier (CC). In LTE, each cell only has one CC, and each UE only has one CC to serve it. However, in LTE-Advanced, it is possible for each UE to have a plurality of CCs to serve it.

Specifically, in LTE-Advanced, each base station might be provided with a plurality of CCs (currently, up to five CCs can be permitted), and the UE is also likely to use a plurality of CCs, but it is not likely that the UEs will use all the CCs. The base station, namely, eNB, can configure/reconfigure the component carrier for the user equipment (UE) via a RRC signaling. As far as the UE is concerned, those CCs configured to be used by the UE are called configured CCs, and CCs unused are called non-configured CCs. The configured CCs can be further classified into active CCs and inactive CCs. The eNB can configure/reconfigure CC for the user equipment (UE) via the RRC signaling. The eNB can activate the inactive CCs of the UE to be active CCs by using an activating/deactivating MAC control signaling (MAC CE). On the other hand, the eNB can deactivate the active CCs of the UE to be inactive CCs by using the activating/deactivating MAC CE. Alternatively, active CCs can be implicitly activated in response to a de-activation timer expires. In this mechanism, a de-activation timer is set for the active CCs. When the de-activation timer expires, the corresponding CCs will be de-activated to become inactive CCs.

The UE transmits data on the active CCs and does not transmit any data on the inactive CCs. In terms of scheduling, the eNB can send an uplink scheduling command (UL grant) on a DL CC to schedule data or control information transmission on the corresponding UL CC. The eNB can also schedule data or control information transmission on other UL CCs (namely, UL CCs other than the corresponding UL CCs) , which is called cross scheduling. Such DL CC for carrying a scheduling command is also called a scheduling DL CC.

Currently, it is already provided that each UL CC has a corresponding scheduling DL CC. The user equipment (UE) attempts to decode the uplink scheduling command from the scheduling DL CC to perform UL operation on the corresponding uplink.

In order to save a power consumption of the UE, the UE does not attempt to receive a physical downlink control channel (PDCCH)/physical downlink shared channel (PDSCH) from the inactive DL CC. Therefore, when the UL CC's scheduling DL CC is de-activated, the UE will not receive any uplink scheduling command (UL grant) for the UL CC, whereby operations of the corresponding UL CC's HARQ process will be affected.

Therefore, there is a need for an improved solution for processing an uplink component carrier hybrid automatic repeat request (UL CC HARQ) process, which can solve the above problems.

### SUMMARY OF THE INVENTION

In view of problems exiting in the prior art, embodiments of the present invention provide an improved method and apparatus for processing an uplink component carrier hybrid automatic repeat request (UL CC HARQ) process.

According to an embodiment of the present invention, there is provided a method for processing a UL CC HARQ process of a carrier aggregation system, comprising: receiving an indication that a DL CC is de-activated; stopping receiving a physical hybrid retransmission indicator channel (PHICH) from the de-activated DL CC; and stopping processing the UL HARQ process of the UL CC scheduled by the de-activated DL CC.

The indication that the DL CC is de-activated specifically depends on a trigger mechanism of the de-activated DL CC. For example, the indication can be an activating/deactivating MAC CE of the de-activated DL CC sent by the base station to the user equipment. Alternatively, the indication can be a signal indicating that a de-activation timer of the DL CC expires.

According to a preferred embodiment of the present invention, the UE automatically can flush all the UL HARQ process buffers corresponding to the UL CC according to the indication that the DL CC is de-activated, thereby stopping processing the UL HARQ process of the UL CC scheduled by the de-activated DL CC.

According to another preferred embodiment of the present invention, the UE may, according to the indication that the DL CC is de-activated, automatically suspend all the UL HARQ process operations corresponding to the UL CC, and maintain the corresponding UL HARQ process buffer. In this embodiment, the UE can further resume these suspended UL HARQ process operations shortly thereafter according to an eNB's command to avoid data loss.

According to another embodiment of the present invention, there is provided a method for processing a UL CC HARQ process of a carrier aggregation system, comprising: determining a UL CC scheduled by a downlink component carrier DL CC which is to be de-activated; sending a virtual HARQ ACK before the DL CC is de-activated, regardless whether a result of decoding transmission from the UL CC is successful, so that a UE stops processing the UL HARQ process of the UL CC scheduled by the DL CC.

According to a further embodiment of the present invention, there is provided a method for processing a UL CC HARQ process of a carrier aggregation system, comprising: receiving a virtual HARQ ACK; and stopping processing a corresponding UL HARQ process according to the virtual HARQ ACK, wherein the virtual HARQ ACK is sent before a DL CC is de-activated, regardless whether the result of decoding by a base station transmission of the UL CC scheduled by the DL CC is successful.

Preferably, the UE suspends processing the corresponding UL HARQ process according to the virtual HARQ ACK, and maintains the corresponding UL HARQ process buffer. As such, shortly thereafter, the UE can further resume these suspended operations of the UL HARQ process shortly thereafter according to an eNB's command to avoid data loss.

According to a further embodiment of the present invention, there is provided an apparatus for processing a UL CC HARQ process of a carrier aggregation system, the apparatus comprising: receiving means configured for receiving an indication that a DL CC is de-activated; PHICH stopping means configured for stopping receiving the PHICH from the de-activated DL CC; and HARQ stopping means configured for stopping processing the HARQ process of the UL CC scheduled by the de-activated DL CC.

According to a further embodiment of the present invention, there is provided an apparatus for processing a UL CC HARQ process of a carrier aggregation system, the apparatus comprising: determining means configured for determining a UL CC scheduled by a downlink component carrier DL CC which is to be de-activated; sending means configured for sending a virtual HARQ ACK before the DL CC is de-activated, regardless whether a result of decoding a transmission from the UL CC is successful, so that a user equipment UE stops processing the UL HARQ process of the UL CC scheduled by the DL CC.

According to a further embodiment of the present invention, there is provided an apparatus for processing a UL CC HARQ process of a carrier aggregation system, the apparatus comprising: receiving means configured for receiving a virtual HARQ ACK which is sent before the DL CC is de-activated, regardless whether the result of decoding by a base station transmission of the UL CC scheduled by the DL CC is successful; and HARQ stopping means configured for stopping processing a corresponding UL HARQ process according to the virtual HARQ ACK.

### BRIEF DESCRIPTION OF THE ACCOMPANYING DRAWINGS

Other features, objects and advantages of the present invention will be made more apparent by reading through the following detailed description of non-limiting embodiments with reference to the drawings. In the figures, like reference numerals denote identical or like elements, wherein:

FIG. 1 illustrates a schematic view of a UL CC in a LTE-Advanced system and a DL CC scheduled by the UL CC.

FIG. 2 illustrates a flowchart of a method for processing a UL CC HARQ process of a carrier aggregation system according to a first embodiment of the present invention.

FIG. 3 illustrates a flowchart of a method for processing a UL CC HARQ process of a carrier aggregation system according to a second embodiment of the present invention.

FIG. 4 illustrates a flowchart of a method for processing a UL CC HARQ process of a carrier aggregation system at an eNB side according to a third embodiment of the present invention.

FIG. 5 illustrates a flowchart of a method for processing a UL CC HARQ process of a carrier aggregation system at a UE side according to the third embodiment of the present invention.

FIG. 6 illustrates a flowchart of a user-side apparatus for processing a UL CC HARQ process of a carrier aggregation system according to an embodiment of the present invention.

FIG. 7 illustrates a flowchart of a base station-side apparatus for processing a UL CC HARQ process of a carrier aggregation system according to another embodiment of the present invention.

FIG. 8 illustrates a flowchart of a user-side apparatus for processing a UL CC HARQ process of a carrier aggregation system according to another embodiment of the present invention.

### DETAILED DESCRIPTION OF PREFERRED EMBODIMENTS

A method and an apparatus for processing a UL CC HARQ process of a carrier aggregation system according to the present invention are described hereunder in combination with the figures and with reference to specific embodiments.

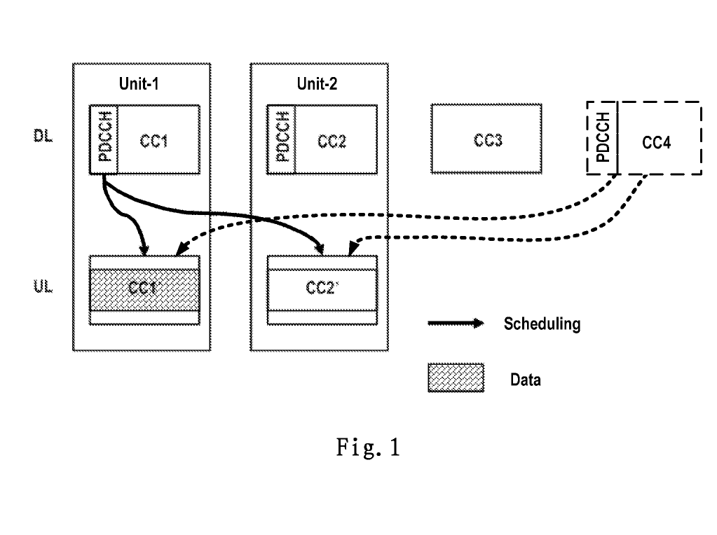

FIG. 1 illustrates a schematic view of a UL CC in a LTE-Advanced system and a DL CC scheduled by it. The system shown in FIG. 1, there are provided three DL CCs, namely, CC1, CC2 and CC3, and provided two UL CCs, namely, CC1′ and CC2′, wherein CC1 and CC1′ form a unit and CC2 and CC2′ form another unit. There is not a UL CC matching CC3. According to current requirements of LET-Advanced, an eNB configure/reconfigures, through a RRC signaling, only one DL CC to each UL CC as its scheduling DL CC. A UE will attempts to decode from its scheduling DL CC an uplink scheduling command for its UL CC operation. In the case as shown in FIG. 1, the eNB configures CC1 as a scheduling DL CC for uplinks CC1′ and CC2′. When CC1 is an active CC, the eNB will send an uplink scheduling command (as shown by the arrow) for CC1′ and CC2′ on a PDCCH of the CC1. The UE will attempt to decode from CC1 an uplink scheduling command for operations of CC1′ and CC2′.

According to the current LTE-Advanced protocol, the active CC can be de-activated for power saving purpose. There are two triggering mechanisms to de-activate one DL CC: (1) the eNB explicitly de-activates by activating/de-activating MAC CE; and (2) the eNB implicitly de-activates when a de-activation timer expires. For power saving purpose, CC1 in FIG. 1 might be de-activated according to any one of the above mechanisms. According to the two triggering mechanisms, there are two kinds of indications for indicating that the DL CC is de-activated. In Mechanism 1, an activating/deactivating MAC CE can indicate that the DL CC is de-activated. In Mechanism 2, a signal indicative of expiration of the de-activation timer can indicate the DL CC is de-activated.

According to the current LTE-Advanced protocol, the UE will not attempt to decode the PDCCH/PDSCH from the de-activated DL CC. However, whether the UE can receive the PHICH from the de-activated DL CC has not been discussed yet. Considering the UE attempts to receive the PHICH from the de-activated DL CC, the advantage of enabling the UE to save power by de-activating the DL CC will not be realistic any more. Therefore, according to the embodiment of the present invention, it is proposed that the UE does not detect the PHICH from the de-activated DL CC for power saving purpose.

According to another current LTE-Advanced protocol, the PHICH for UL transmission is sent on the DL CC carrying its uplink scheduling command. In other words, the uplink scheduling command and the corresponding PHICH are both sent on the UL CC's scheduling DL CC.

In this case, when the scheduling DL CC is de-activated, the UE will not receive the uplink scheduling command for the UL CC scheduled by the DL CC. This will exert an adverse influence on the processing of the HARQ process of these UL CCs. In the text below, these UL CCs are also called impacted UL CCs. The corresponding HARQ process is called an impacted UL CC HARQ process. For instance, when the CC1 in FIG. 1 is de-activated, the HARQ process of CC1′ and CC2′ will be affected.

Specifically, based on synchronous UL HARQ strategy, even if the UE does not receive any uplink scheduling command, the UE will automatically perform UL non-adaptive retransmission. Referring to FIG. 1, when the CC1 is de-activated, the UE will not attempt to decode the PDCCH/PDSCH from the de-activated CC1 so that the uplink scheduling command for CC1′ and CC2′ cannot be received. Therefore, the UE will automatically perform non-adaptive retransmission of CC1′ and CC2′. For example, each CC can have eight HARQ processes at most. According to the embodiment of the present invention, when the scheduling DL CC is de-activated, the UE cannot receive from the de-activated scheduling DL CC the PHICH with respect to these automatic non-adaptive retransmissions. Hence, the UE will automatically continue to perform endless UL non-adaptive retransmission until the predetermined number of times of retransmission is reached, because no PHICH means HARQ NACK from the perspective of the UE. Apparently, this endless automatic UL retransmission will consume a large amount of power and is unfavorable for power saving of the UE, and does not produce any benefits to maximization of the UL performance. In addition, this endless automatic retransmission will lead to UL interference because the eNB may have assigned the related resource to other UE.

Therefore, according to the embodiment of the present invention, it is proposed that the UE should stop its impacted UL CC HARQ process operation when the scheduling DL CC is de-activated, thereby achieving more power saving of the UE and reducing the UL interference.

According to the embodiment of the present invention, two options are proposed to stop UL CC HARQ operation of the UE:

Option 1: the UE flush impacted UL CC HARQ process buffer; and

Option 2: the UE suspends its impacted UL CC HARQ process operation and maintains the corresponding UL CC HARQ process buffer.

As for Option 1, when the UL CC's scheduling DL CC is de-activated, the UE flushes all the impacted UL CC HARQ process buffers. For example, when the CC1 in FIG. 1 is de-activated, all the HARQ process buffers of CC′ and CC2′s scheduled by the CC1 will be flushed. There is no potential UL CC HARQ process to be operated since the corresponding HARQ process buffer is empty. This option is simple but may lead to data loss. For instance, if data transmission is confronted with malfunction, the eNB sends HARQ NACK. Originally, the UE will receive the HARQ NACK and carries out retransmission. However, since the UL HARQ buffers are already flushed, retransmission will not be carried out and therefore data loss is possible. In this case, the resultant data loss can be solved by retransmission of an RLC signaling coverage at a higher layer.

As for Option 2, the UE suspends all the impacted UL CC HARQ process operation, but maintains the corresponding UL CC HARQ process buffer. In this option, the endless automatic non-adaptive retransmission will not be caused. There are two schemes which can be used to implement Option 2:

Scheme 1: the eNB explicitly sends a virtual HARQ ACK to a UE before the DL CC is de-activated.

Scheme 2: new UE behavior is defined so that the UE operates as if the ACK is received when the scheduling DL CC is de-activated.

According to the current LTE-Advanced protocol, after the eNB successfully decodes the UL transmission, the HARQ ACK is sent. After the UE receives the HARQ ACK, the UE should suspend its operation of UL HARQ process and maintains the corresponding UL HARQ process buffer. It should be appreciated that as compared with the flushing of the corresponding UL HARQ process buffer after the HARQ ACK is received, the advantage of so doing is to avoid data loss caused by occurrence of NACK->ACK signaling error.

Based on this requirement, in the solution of Scheme 1, before the DL CC is de-activated, the eNB sends down a HARQ ACK to all the impacted UL HARQ processes to be retransmitted regardless whether a decoding result of its corresponding UL transmission is successful. The HARQ ACK is also called a virtual HARQ ACK because it is transmitted not in the event of making sure that the UL transmission is successfully decoded. As above stated, there are two triggering mechanisms to de-activate the DL CC. If the eNB explicitly de-activates by activating/de-activating MAC CE, the eNB will send the virtual HARQ ACK before sending the activating/deactivating MAC CE which indicating to de-activate the DL CC. If the DL CC is implicitly de-activated when the de-activation timer expires, and the eNB knows a state of the de-activation timer, the eNB can send the virtual HARQ ACK before the de-activation timer expires. Therefore, after the UE receives the HARQ ACK, it will suspend its operation of UL HARQ process, and maintain the corresponding UL CC HARQ process buffer. As such, when the DL CC scheduled by the UL CC is de-activated, the UE has already suspended all the impacted UL HARQ processes, thereby avoiding any potential UL HARQ operation. This scheme also has drawbacks which can cause a delay in sending the activating/deactivating MAC CE because it follows all the HARQ ACKs already sent.

Regarding Scheme 2, there is a need to define a new UE operation to suspend the impacted UL HARQ process when its scheduling DL CC is de-activated, and maintain the corresponding UL HARQ process buffer. In other words, when the scheduling DL CC is de-activated/removed, the UE operate as if HARQ ACK is received, although no HARQ ACK is received actually.

Preferably, as for Option 2, the eNB will take action to resume the operation of UL HARQ process suspended by the UE. This aspect can be implemented by the following two steps:

Step 1: the eNB instructs the UE to begin to resume decoding the PDCCH/PHICH for the corresponding UL HARQ process; and

Step 2: the eNB instructs the UE to resume performing the suspended UL HARQ process operation.

In order to perform Step 1, the eNB can send a RRC signaling or a new activating/deactivating MAC CE to the UE. The former is used to configure another DL as the impacted UL CC's scheduling DL CC of the UE while the latter is used to activate its previous de-activated scheduling DL CC. Referring to FIG. 1, at a certain time after the CC1 is de-activated, the eNB can, through the RRC signaling, configure a new DL CC, such as CC4, as the scheduling DL CC of CC1′ and CC2′. CC4 can be either an active CC or a inactive CC. If the configured scheduling DL CC is a inactive CC, the eNB can activate the CC by sending the activating/deactivating MAC CE. After Step 1, the UE restarts to detect the PDCCH/PHICH for the its impacted UL CC on the activated scheduling DL CC. In Step 2, the eNB sends to the UE an uplink scheduling command for the impacted UL CC, and the UE resumes performing its suspended UL HARQ process operation according to the uplink scheduling command. If the uplink scheduling command is for a new transmission, the UE should flush the current UL CC HARQ process buffer to perform the new transmission. Otherwise, the UE performs the adaptive retransmission according to data in its current HARQ process buffer and the received uplink scheduling command.

Embodiments of the present invention will be described in detail with reference to figures.

According to some embodiments of the present invention, the present invention proposes a method for making improvements at the user side to process the impacted UL CC HARQ process in a carrier aggregation system in the case that the scheduling DL CC is de-activated. The method comprises: receiving an indication that the DL CC is de-activated; stopping receiving a physical hybrid retransmission indicator channel PHICH from the de-activated DL CC; and stopping processing the UL HARQ process of the UL CC scheduled by the de-activated DL CC.

The indication that the DL CC is de-activated depends on a trigger mechanism of the de-activated DL CC. For example, in the case that the DL CC is de-activated via the MAC CE, the indication can be the activating/deactivating MAC CE of the de-activated DL CC sent by the base station to the user equipment. Alternatively, in the case that the DL CC is de-activated implicitly when the deactivation timer expires, the indication can be a signal indicating that the de-activation timer of the DL CC expires.

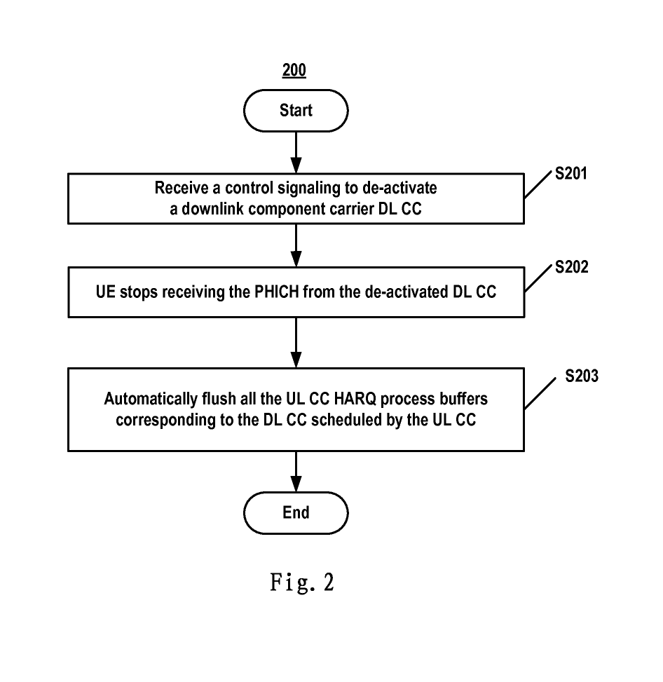

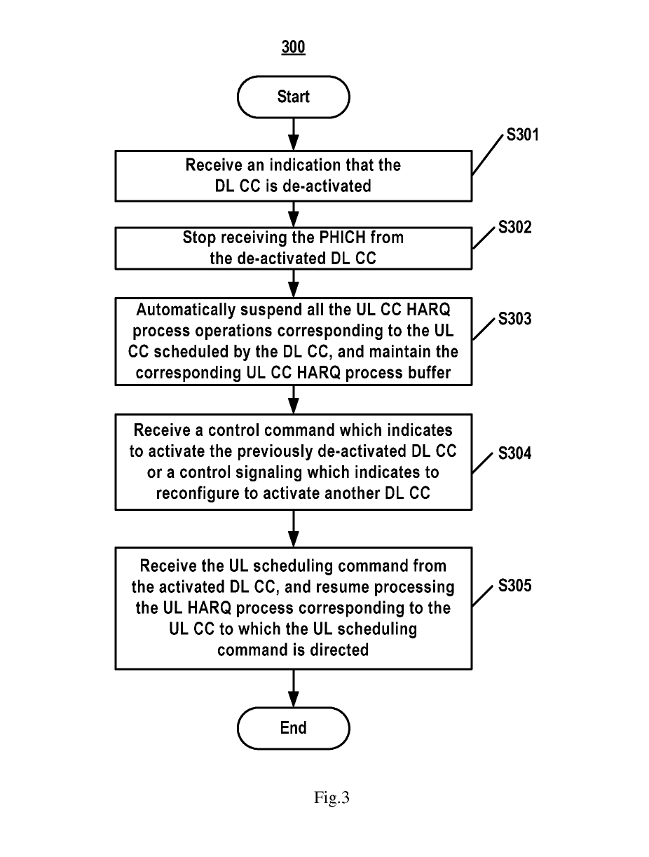

Stopping processing the UL CC HARQ process scheduled by the de-activated DL CC can be implemented in many ways. For example, according to an embodiment of the present invention, it may be implemented by flushing the corresponding UL CC HARQ process buffer. According to another embodiment of the present invention, it may be implemented by suspending the corresponding UL CC HARQ process operation and maintaining the corresponding UL CC HARQ process buffer. Specific depictions will be presented with reference to FIG. 2 and FIG. 3.

FIG. 2 illustrates a flowchart of a method for processing a UL CC HARQ process of a carrier aggregation system according to a first embodiment of the present invention. As shown in FIG. 2, in Step S201, the UE receives an indication that the DL CC is de-activated. The indication is for example the activating/deactivating MAC CE or a signal indicating that the de-activation timer expires. In Step S202, the UE stops receiving the PHICH from the de-activated DL CC. In Step S203, the UE automatically flushes all the UL CC HARQ process buffers corresponding to the UL CC scheduled by the DL CC according to the indication that the DL CC is de-activated, thereby stopping the processing for all the impacted UL CC HARQ processes.

FIG. 3 illustrates a flowchart of a method 300 for processing a UL CC HARQ process of a carrier aggregation system according to a second embodiment of the present invention. In Step S301, the UE receives an indication that the DL CC is de-activated. The indication is for example the activating/deactivating MAC CE or a signal indicating that the de-activation timer expires. In Step S302, the UE stops receiving the PHICH from the de-activated DL CC. In Step S303, according to the indication that the DL CC is de-activated, the UE automatically suspends all the UL CC HARQ process operations corresponding to the UL CC scheduled by DL CC, and maintains the corresponding UL CC HARQ process buffer.

Preferably, the method 300 further comprises a step of resuming the UL CC HARQ process operation. As shown in FIG. 3, in Step S304, the UE receives a control command which indicates to activate the previously de-activated DL CC or a control signaling which indicates to reconfigure to activate another DL CC. For example, the previously de-activated DL CC is activated via the activating/deactivating MAC CC. Alternatively, a new DL CC may be reconfigured as the impacted UL CC's scheduling DL CC via a RRC signaling. The new DL CC can be either an active CC or an inactive CC. In the event of the inactive CC, it can be then activated via the activating/deactivating MAC CC. Then, in Step 305, the UE receives the uplink scheduling command from the activated DL CC, and resumes processing the UL HARQ process corresponding to the UL CC to which the uplink scheduling command is directed. If the uplink scheduling command is for a new transmission, the UL HARQ process buffer corresponding to the UL CC to which the uplink scheduling command is directed will be flushed for use of the new transmission; and if the uplink scheduling command is for a retransmission, the adaptive retransmission will be performed.

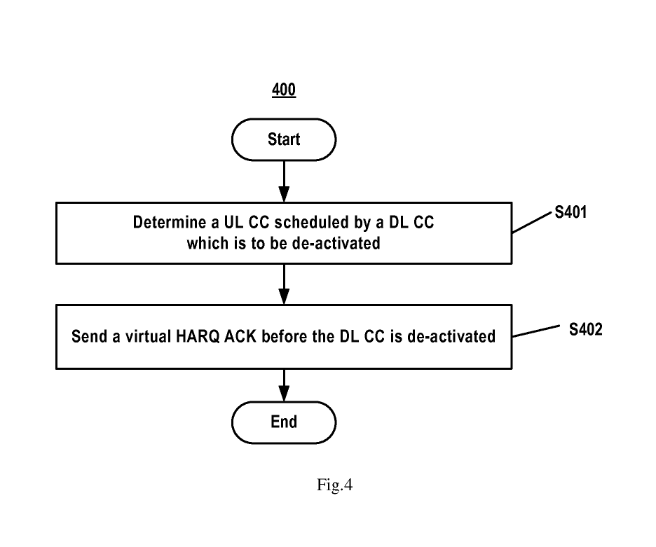

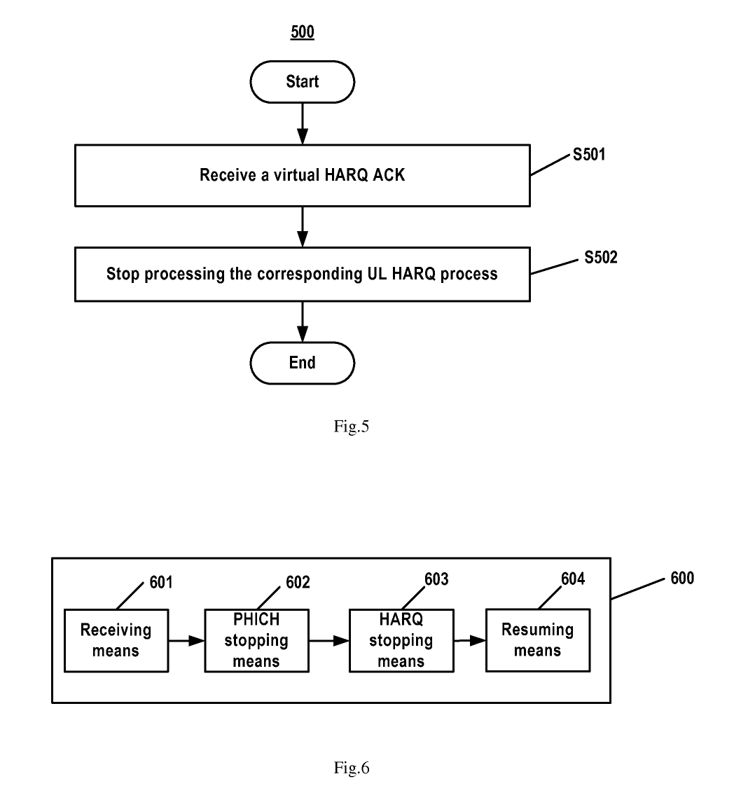

According to another embodiment of the present invention, the present invention proposes a method for making improvements at the base station side to process the impacted UL CC HARQ process in a carrier aggregation system in the case that the scheduling DL CC is de-activated. Specific depictions will be presented with reference to FIG. 4 and FIG. 5.

FIG. 4 illustrates a flowchart of a method 400 for processing a UL CC HARQ process of a carrier aggregation system on an eNB side according to a third embodiment of the present invention. In Step 401, the eNB determines the UL CC scheduled by the DL CC which is to be de-activated. In Step 402, before the DL CC is de-activated, regardless whether a result of decoding a transmission from the UL CC scheduled by the DL CC is successful, the eNB sends a virtual HARQ ACK so that the user equipment UE stops processing the UL HARQ process of the UL CC scheduled by the de-activated DL CC.

FIG. 5 illustrates a flowchart of a method 500 for processing a UL CC HARQ process of a carrier aggregation system on a UE side according to the third embodiment of the present invention. As shown in FIG. 5, in Step S501, the UE receives the virtual HARQ ACK. In Step S502, the UE stops processing the corresponding UL HARQ process according to the virtual HARQ ACK. For example, according to the requirement of the current LTE criteria, the UE suspends the corresponding UL HARQ process operation and maintains the corresponding UL HARQ process buffer. It should be appreciated that the HARQ ACK is usually sent after the eNB successfully decodes the transmission from the UL CC. However, the virtual HARQ ACK herein is sent before the DL CC is de-activated, regardless whether the base station's decoding result of transmission of the UL CC scheduled by the de-activated DL CC is successful.

Referring back to FIG. 4, under circumstances that the DL CC is de-activated via the MAC CE, the eNB can send the activating/deactivating MAC CE of the de-activated DL CC after sending the virtual HARQ ACK for all the impacted UL CC HARQ processes. Then, the UE receives the MAC CE of the de-activated DL CC, and then stops receiving the PHICH from the de-activated DL CC.

Under the circumstances that the DL CC is implicitly de-activated when the de-activation timer expires, if the eNB knows the state of the de-activation timer, it is also clear about when the DL CC is to be de-activated. As such, as stated in the above Step 402, before the DL CC is de-activated, the virtual HARQ ACK is sent for all the impacted UL CC HARQ processes. Then, the UE receives the signal indicating that the de-activation timer of the DL CC expires, and then stops receiving the PHICH from the de-activated DL CC.

It should be appreciated that when the DL CC is de-activated, the UE has already suspended the processing of all the impacted UL CC HARQ processes, thereby avoiding the problem that the impacted HARQ process does not know how to operate after the scheduling DL CC is de-activated, and avoiding the endless automatic non-adaptive retransmission.

Similar to the second embodiment, the method as illustrated in the third embodiment can also comprise a step of resuming the UL CC HARQ process operation. For example, the method as illustrated in FIG. 4 can further comprise an additional resuming step. Specifically, in a period of time after the DL CC is de-activated, the eNB can send a control signaling which indicates to activate the de-activated DL CC or reconfigure to activate another DL CC. After receiving the control signaling (e.g., the RRC or MAC CE) for activating the DL CC, the UE restarts to detect the PDCCH/PHICH for the its impacted UL CC on the newly-activated DL CC. Therefore, the UE can receive from the activated scheduling DL CC the uplink scheduling command for the impacted UL CC sent by the eNB, and resume performing its suspended UL CC HARQ process operation. If the uplink scheduling command is for a new transmission, the UE flushes the current UL CC HARQ process buffer to perform the new transmission. Otherwise, the UE performs the adaptive retransmission according to data in its current HARQ process buffer and the received uplink scheduling command.

FIG. 6 illustrates a flowchart of a user-side apparatus 600 for processing a UL CC HARQ process of a carrier aggregation system according to an embodiment of the present invention. The apparatus 600 is for example a user equipment UE in the LTE-A system, or included in the UE. The UE can be for example a mobile telephone, a portable compute or personal digital assistant supporting wireless communication, and/or other apparatuses supporting wireless communication. The apparatus 600 comprises receiving means 601, PHICH stopping means 602 and HARQ stopping means 603, wherein the receiving means 601 is used to receive an indication that the DL CC is de-activated. The indication is for example the activating/deactivating MAC CE or a signal indicating that the de-activation timer expires. The PHICH stopping means 602 is used to stop receiving the PHICH from the de-activated DL CC. The HARQ stopping means 603 is used to stop processing the HARQ process of the UL CC scheduled by the de-activated DL CC.

According an embodiment of the present invention, the HARQ stopping means 603 comprises flushing means configured for automatically flushing all the HARQ process buffers corresponding to the UL CC according to the indication that the DL CC is de-activated.

According to another embodiment of the present invention, the HARQ stopping means 603 comprises hang-up means configured for, according to the indication that the DL CC is de-activated, automatically suspending all the UL HARQ process operations corresponding to the UL CC scheduled by the de-activated DL CC, and maintaining the corresponding UL HARQ process buffer.

According to a preferred embodiment of the present invention, the receiving means 601 is further configured to receive a control signaling which indicates to activate the de-activated DL CC or reconfigure to activate another DL CC. Alternatively, the apparatus 600 further comprises resuming means 604 configured for receiving the uplink scheduling command from the activated DL CC, and resuming processing the UL HARQ process corresponding to the UL CC to which the uplink scheduling command is directed.

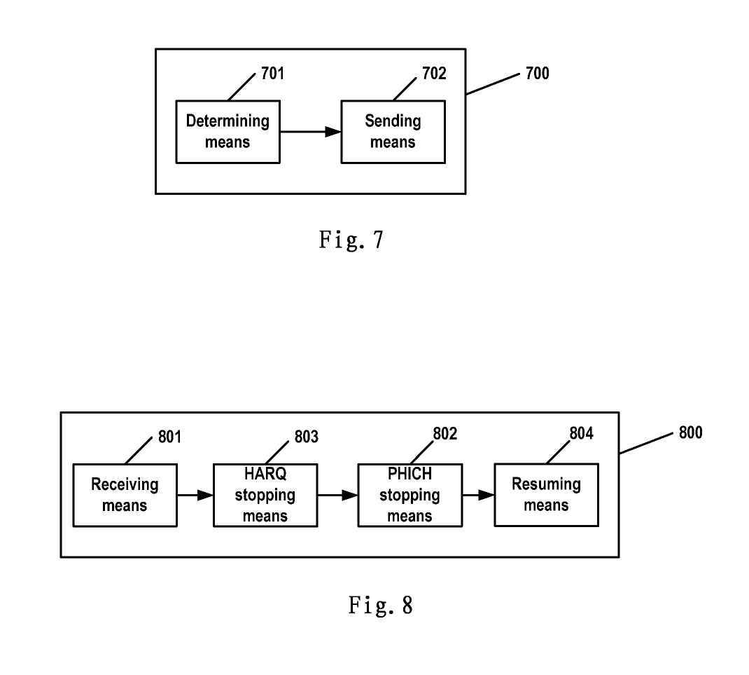

FIG. 7 illustrates a flowchart of a base station-side apparatus 700 for processing a UL CC HARQ process of a carrier aggregation system according to another embodiment of the present invention. The apparatus 700 can be for example an eNB in the LTE A system, or included in the eNB. The apparatus 700 comprises determining means 701 and sending means 702, wherein the determining means 701 is used to determine the UL CC scheduled by the DL CC which is to be de-activated. The sending means 702 is used to send a virtual HARQ ACK before the DL CC is de-activated, regardless whether a result of decoding a transmission from the DL CC-scheduled UL CC is successful, so that the user equipment UE stops processing the UL HARQ process of the UL CC scheduled by the DL CC. Preferably, the sending means 702 is further used to send a MAC signaling for activating/de-activating the DL CC, and/or an RLC signaling for reconfiguring the DL CC.

FIG. 8 illustrates a flowchart of a user-side apparatus 800 for processing a UL CC HARQ process of a carrier aggregation system according to another embodiment of the present invention. The apparatus 800 is for example a user equipment UE in the LTE A system, or included in the UE. The UE can be for example a mobile telephone, a portable compute or personal digital assistant supporting wireless communication, and/or other apparatuses supporting wireless communication. The apparatus 800 comprises receiving means 801 and HARQ stopping means 803, wherein the receiving means 801 is configured to receive a virtual HARQ ACK which is sent before the DL CC is de-activated, regardless whether the base station's decoding result of transmission of the UL CC scheduled by the DL CC is successful. The HARQ stopping means 803 is configured to stop processing the corresponding UL HARQ process according to the virtual HARQ ACK. Preferably, the HARQ stopping means 803 comprises hang-up means for suspending the processing of the corresponding UL HARQ process, and maintaining the corresponding UL HARQ process buffer.

Preferably, the receiving means 801 is further used to receive an indication that the DL CC is de-activated. The indication is for example the activating/deactivating MAC CE or a signal indicating that the de-activation timer expires. Preferably, the apparatus 800 further comprises PHICH stopping means 802 for stopping receiving the PHICH from the de-activated DL CC.

According to a preferred embodiment of the present invention, the receiving means 801 is further configured to receive a control signaling which indicates to activate the previously de-activated DL CC or reconfigure to activate another DL CC. The control signaling is for example a MAC signaling for activating/de-activating the DL CC, and/or an RLC signaling for reconfiguring the DL CC. The apparatus 800 further comprises resuming means 804 for receiving the uplink scheduling command from the activated DL CC, and resuming processing the UL HARQ process corresponding to the UL CC to which the uplink scheduling command is directed. If the uplink scheduling command is for a new transmission, the UE should flush the current UL CC HARQ process buffer to perform the new transmission. Otherwise, the UE performs the adaptive retransmission according to data in its current HARQ process buffer and the received uplink scheduling command.

According to the embodiment of the present invention, in a carrier aggregation system, when the DL CC is de-activated, the processing of the HARQ process corresponding to the impacted UL CC will be stopped in order to avoid a processing error in the HARQ process. In addition, useless automatic non-adaptive retransmission is avoided, resources are saved and UL interference is reduced, as well as the power consumption of a UE is better saved.

Embodiments of the present invention are described as above. It should be appreciated that the embodiments described above are exemplary not limiting. The steps as listed are not indispensable, and their order are not restrictive. For example, according to different embodiments, it is possible to stop receiving the PHICH first, and then stop the impacted UL CC HARQ process operation, or it is possible to do in an opposite order. As practically needed, some steps can be added or deleted, or the above steps can be performed in a different order, or some steps can be performed in parallel. Also, the apparatus for processing the UL CC HARQ process as described can further comprise more or less units.

It should be noted that in order to make the present invention more comprehensible, the above description omits some more specific technical details which are known to the skilled in the art and may be essential to implement the present invention.

The purpose for providing the description of the present invention is to exemplarily explain and describe, not to exhaust or limit the present invention within the disclosed form. To those skilled in the art, various modifications and alternations are obvious. The skilled in the art may further understand, the method and apparatus in the embodiments of the present invention may be implemented through software, hardware, firmware, or their combination. The hardware part may be implemented with a dedicated logic; the software part may be stored in a memory and executed by an appropriate instruction execution system, for example a microprocessor, a computer or a mainframe.

Thus, it should be noted that, selecting and describing the preferred embodiments is to better illustrate the principle and practical application of the present invention and to enable a person of normal skill in the art to appreciate that without departing the spirit of the present invention, all modifications and alterations fall within the protection scope of the present invention as limited by the appending claims.

1. A method for processing an uplink component carrier UL CC hybrid automatic repeat request HARQ process of a carrier aggregation system, comprising:
receiving an indication that a downlink component carrier DL CC is de-activated;
stopping receiving a physical hybrid retransmission indicator channel PHICH from the de-activated DL CC; and
stopping processing the UL HARQ process of the UL CC scheduled by the de-activated DL CC.

2. The method according to claim 1, wherein stopping processing the UL HARQ process of the UL CC comprises: according to the indication that the DL CC is de-activated, automatically flushing all the UL HARQ process buffers corresponding to the UL CC.

3. The method according to claim 1, wherein stopping processing the UL HARQ process of the UL CC comprises: according to the indication that the DL CC is de-activated, automatically suspending all the UL HARQ process operations corresponding to the UL CC, and maintaining the corresponding UL HARQ process buffer.

4. The method according to claim 3, further comprising:
receiving a control signaling which indicates to activate the de-activated DL CC or reconfigure to activate another DL CC;
receiving an uplink scheduling command from the activated DL CC, and resuming processing the UL HARQ process corresponding to the UL CC to which the uplink scheduling command is directed.

5. The method according to claim 4, wherein resuming processing the UL HARQ process corresponding to the UL CC to which the uplink scheduling command is directed further comprises:
if the uplink scheduling command is for a new transmission, the UL HARQ process buffer, corresponding to the UL CC to which the uplink scheduling command is directed, is flushed for use of the new transmission; and
if the uplink scheduling command is for a retransmission, an adaptive retransmission is performed.

6. A method for processing an uplink component carrier UL CC hybrid automatic repeat request HARQ process of a carrier aggregation system, comprising:
determining a UL CC scheduled by a downlink component carrier DL CC which is to be de-activated;
sending a virtual HARQ ACK before the DL CC is de-activated, regardless whether a result of decoding transmission from the UL CC is successful, so that a user equipment UE stops processing the UL HARQ process of the UL CC scheduled by the DL CC.

7. A method for processing an uplink component carrier UL CC hybrid automatic repeat request HARQ process of a carrier aggregation system, comprising:
receiving a virtual HARQ ACK; and
stopping processing a corresponding UL HARQ process according to the virtual HARQ ACK,
wherein the virtual HARQ ACK is sent before a DL CC is de-activated, regardless whether the result of decoding by a base station transmission of the UL CC scheduled by the DL CC is successful.

8. The method according to claim 7, wherein stopping processing the corresponding UL HARQ process comprises: suspending processing the corresponding UL HARQ process, and maintaining the corresponding UL HARQ process buffer.

9. The method according to claim 7, further comprising:
receiving an indication that a downlink component carrier DL CC is de-activated; and
stopping receiving a physical hybrid retransmission indicator channel PHICH from the de-activated DL CC.

10. The method according to claim 7, further comprising:
receiving a control signaling which indicates to activate the de-activated DL CC or reconfigure to activate another DL CC;
receiving the uplink scheduling command from the activated DL CC, and resuming processing the UL HARQ process corresponding to the UL CC to which the uplink scheduling command is directed.

11. The method according to claim 10, wherein resuming processing the UL HARQ process corresponding to the UL CC for to the uplink scheduling command is directed further comprises:
if the uplink scheduling command is for a new transmission, the UL HARQ process buffer, corresponding to the UL CC to which the uplink scheduling command is directed, is flushed for use of the new transmission; and
if the uplink scheduling command is for a retransmission, an adaptive retransmission is performed.

12. An apparatus for processing an uplink component carrier UL CC hybrid automatic repeat request HARQ process of a carrier aggregation system, the apparatus comprising:
receiving means configured for receiving an indication that a downlink component carrier DL CC is de-activated;
PHICH stopping means configured for stopping receiving a physical hybrid retransmission indicator channel PHICH from the de-activated DL CC; and
HARQ stopping means configured for stopping processing the HARQ process of the UL CC scheduled by the de-activated DL CC.

13. The apparatus according to claim 12, wherein the HARQ stopping means comprises: flushing means configured for, according to the indication that the DL CC is de-activated, automatically flushing all the UL HARQ process buffers corresponding to the UL CC.

14. (canceled)

15. (canceled)

16. An apparatus for processing an uplink component carrier UL CC hybrid automatic repeat request HARQ process of a carrier aggregation system, the apparatus comprising:
determining means configured for determining a UL CC scheduled by a downlink component carrier DL CC which is to be de-activated;
sending means configured for sending a virtual HARQ ACK before the DL CC is de-activated, regardless whether a result of decoding a transmission from the UL CC is successful, so that a user equipment UE stops processing the UL HARQ process of the UL CC scheduled by the DL CC.

17. An apparatus for processing an uplink component carrier UL CC hybrid automatic repeat request HARQ process of a carrier aggregation system, the apparatus comprising:
receiving means configured for receiving a virtual HARQ ACK, wherein the virtual HARQ ACK is sent before a downlink component carrier DL CC is de-activated, regardless whether the result of decoding by a base station transmission of the UL CC scheduled by the DL CC is successful; and
HARQ stopping means configured for stopping processing a corresponding UL HARQ process according to the virtual HARQ ACK.

18-20. (canceled)
